(19) United States
(12) Patent Application Publication
(10) Pub. No.: US 2023/0051145 A1
(43) Pub. Date: Feb. 16, 2023

(54) Tool or accessory with one handle cover grip

(71) Applicant: Robert Mark Kowalczyk, Vero Beach, FL (US)

(72) Inventor: Robert Mark Kowalczyk, Vero Beach, FL (US)

(21) Appl. No.: 17/402,570

(22) Filed: Aug. 15, 2021

(51) Int. Cl. B25G 1/10; B25B 7/08

(52) U.S. Cl. CPC B25G 1/10; B25B 7/08

(57) ABSTRACT

A tool or accessory that has two parts that needs to be attached comprising of a pin, rivet, screw, etc thru the fulcrum to make it a one part tool. The tools handles is what the invention pertains to. The two handles will be compromised of different grip handles. The said tool or accessory can be comprised of metal or plastic. The over grip that inserts onto the main material of the said tool or accessory can be compromised of rubber or plastic. The handle that does not have the rubber or plastic over grip will have the main tool material as the formed grip.

### BACKGROUND OF INVENTION

A tool or accessory with a fulcrum and more particularly, pliers having two handles, one handle comprised of metal or plastic and the other handle comprised of the same base material but a rubber or plastic over grip will insert over the base material. This will allow one handle to serve as the power handle and the other handle will serve as the comfort handle. One tool or accessory, two handles with two different grips.

### BRIEF SUMMARY OF INVENTION

A tool or accessory that has two parts that needs to be attached comprising of a pin, rivet, screw, etc thru the fulcrum to make it a one part tool. The said tool or accessories handles is what the invention pertains to. The two handles will be compromised of different grip handles. The said tool or accessory can be comprised of aluminum, carbon metal, stainless steel, titanium or plastic. The over grip that inserts onto the left or right handle can be compromised of rubber or plastic for comfort. The handle that does not have the rubber or plastic over grip will have the main tool material as a formed grip handle for power and control.

### BRIEF DESCRIPTION OF DRAWING

FIG. 1. Front view of a normal tool with two of the same grips

FIG. 2. View of a tool with one grip base material handle and other grip with rubber over grip handle.

FIG. 3. View of over grip handle.

FIG. 4. Front view of tool with right handle ready for rubber overgrip.

FIG. 5. Inside view of rubber or plastic insert.

### DETAILED DESCRIPTION OF INVENTION

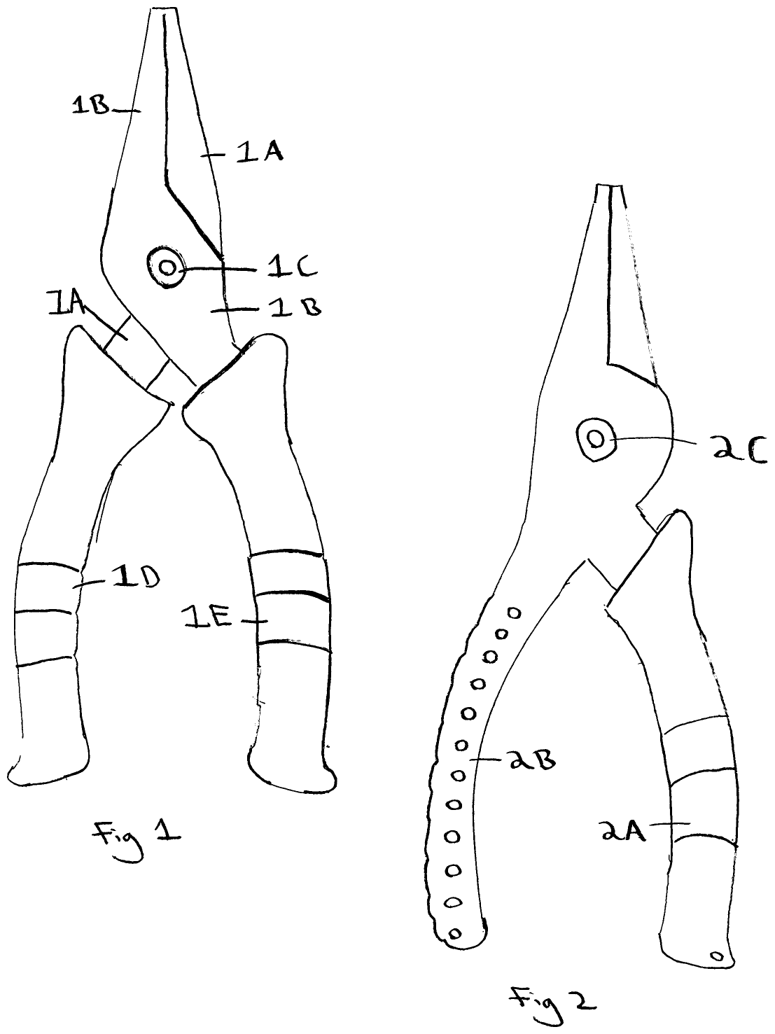

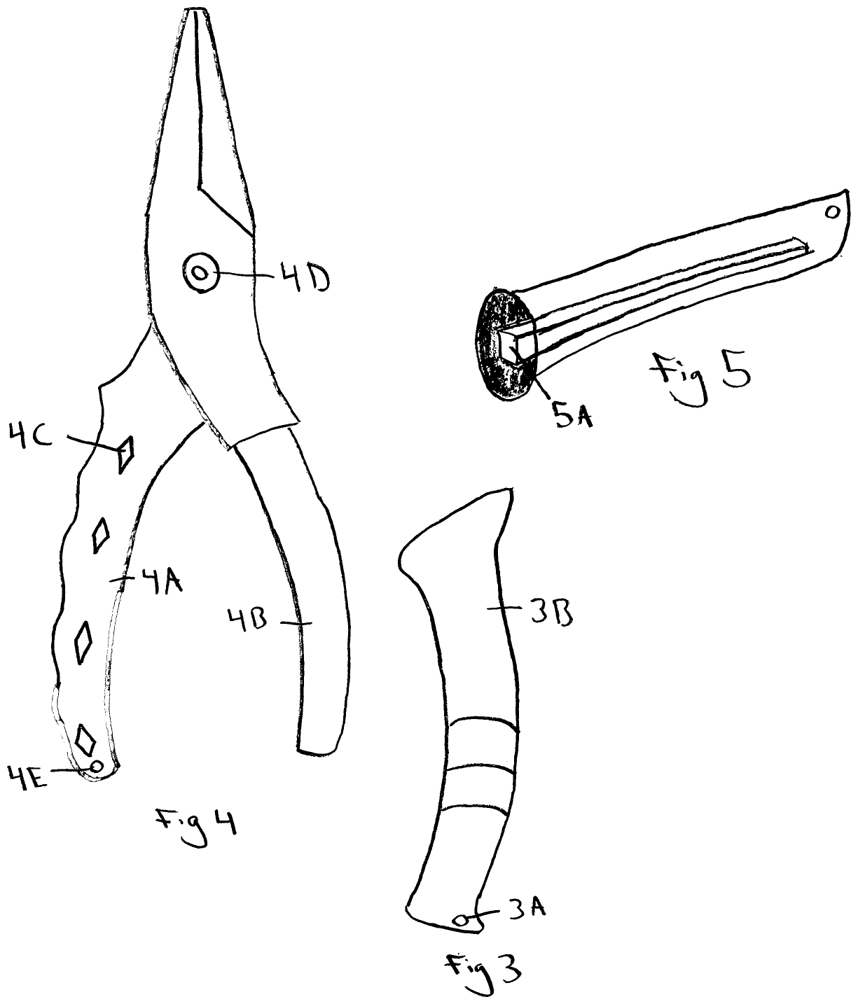

A tool or accessory that has two parts (FIG. 1A, 1B, 4A, 4B) that needs to be attached comprising of a pin, rivet, screw, etc thru the fulcrum (FIG. 1C, 2C, 4D) to make it a one part tool. The tool handles (FIGS. 1D & 1E) is what the invention pertains to. The two handles will be compromised of different grip handles (FIGS. 2B & 2A). The said tool or accessory can be comprised of aluminum, carbon steel, stainless steel, titanium, or plastic. The over grip that inserts onto the main material of the said tool or accessory can be compromised of rubber or plastic (FIGS. 1E, 3B, & FIG. 5). A more detailed view of the insert over grip that goes over the base material can be seen in (FIG. 5A). The handle that does not have the rubber or plastic over grip will have the main tool material as the formed grip (FIGS. 2B & 4A). A variety of designs can be used for the base tool handle (FIGS. 4C & 2B) and for the over grip (FIG. 2B). A hole at the base of the tool can be used on either handle to attach the lanyard (FIGS. 3A & 4E).

1. A tool or accessory that has two parts that needs to be attached comprising of a pin, rivet, screw, etc thru the fulcrum to make it a one part tool is the prime choice for the one tool, two different style handles.

2. A cover/insert handle comprised of rubber of plastic can go onto the left or right handle of the tool or accessory.

3. The overall length, width, and diameter of a said tool or accessory can vary.

4. A said tool or accessory can be compromised of any color and design.

5. A said cover/insert handle can be comprised of any color and design.

6. A said cover/insert handle can be comprised of any length, width, and diameter.

7. A said tool or accessory can have a mount and fastener inserted into the fulcrum to attach to a bracket.

8. A said tool or accessories can have all the same features as a normal said tool or accessory.

9. A said tool or accessory base material can be compromised of aluminum, stainless steel, plastic, titanium, carbon metal.
